(19) United States
(12) Patent Application Publication
(10) Pub. No.: US 2011/0187657 A1
(43) Pub. Date: Aug. 4, 2011

(54) Touch sensitive screen for scrolling through sets of data

(76) Inventor: Ian Robert Knowles, Buckinghamshire (GB)

(21) Appl. No.: 12/931,544

(22) Filed: Feb. 3, 2011

(30) Foreign Application Priority Data
Feb. 4, 2010 (GB) GB 1001853.9

(51) Int. Cl. G06F 3/041

(52) U.S. Cl. 345/173

(57) ABSTRACT

A touch sensitive screen system is provided for strolling through a set of data displayed on the screen. A plurality of touch sensitive areas (A, B, C, D, E) are provided. Contact movement with a central area (A) commences scrolling of data displayed on the screen. Movement of the contact into one of a plurality of edge portions (B, C, D, E) causes scrolling of the data to continue.

This invention relates to touch sensitive screens for scrolling through sets of data.

Touch screens are increasingly common in many devices such as mobile telephones. A good example is the Apple iphone (™) which is an entirely touch screen device. When scrolling through lists of, for example, names. Scrolling is achieved by moving a finger in contact with the screen. This has the effect of moving the list (scrolling) at a speed similar to that of the speed of movement of the finger. Lists can be arranged to gradually decelerate after a finger has been removed. The amount of control is not particularly sophisticated.

We have appreciated that a touch screen can be used to produce a more user friendly and more easily navigable scroll through lists by subdividing the touch screen area into a number of different zones which are used to perform different scrolling related functions.

The invention is defined in the appended claims to which reference should now be made.

A preferred embodiment of the invention will now be described in detail by way of example with reference to the accompanying drawings in which:

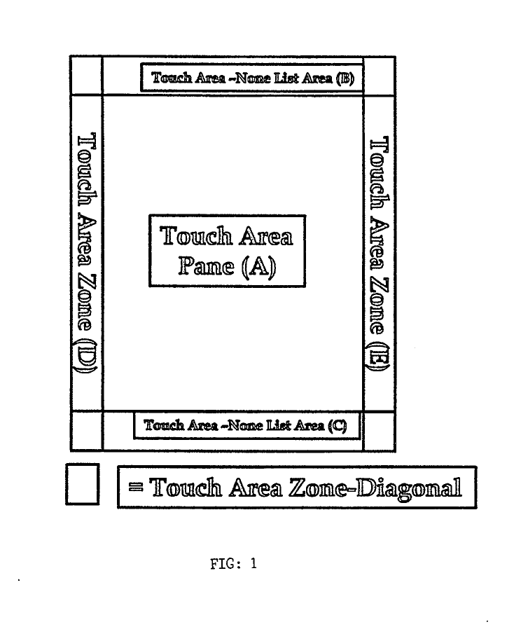

FIG. 1: shows a touch screen divided into a number of different areas for scroll control in accordance with an embodiment of the invention; and

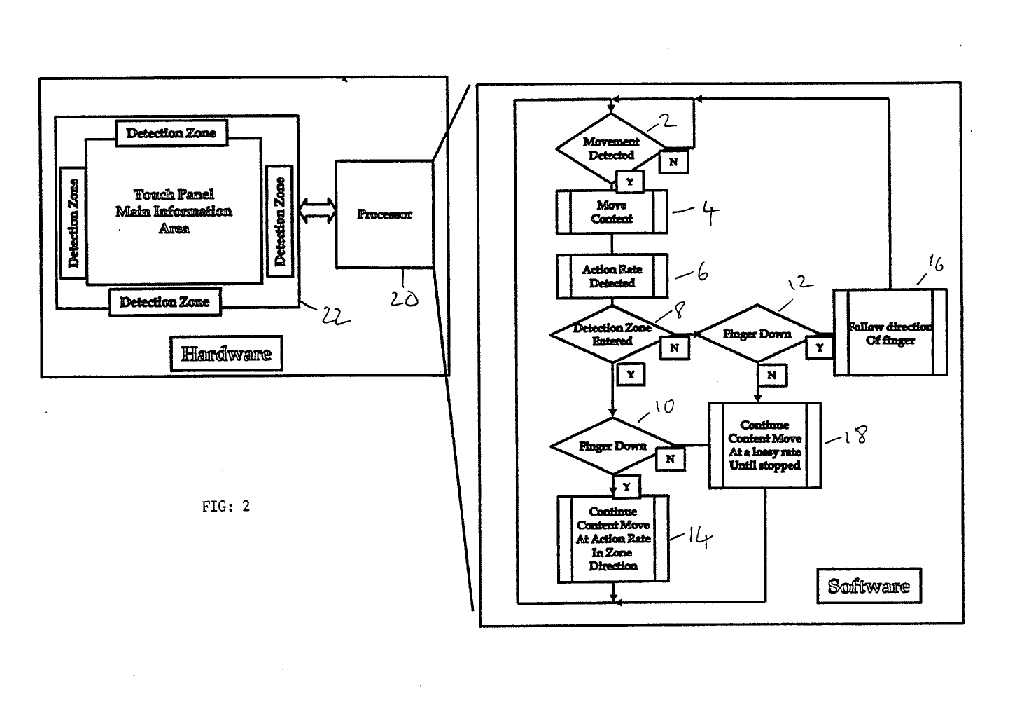

FIG. 2: shows a schematic diagram of the functionality of circuitry/software used to detect signals from the touch screen area to control scrolling.

The diagram of FIG. 1 shows how a touch screen is subdivided into a plurality of areas in accordance with the embodiment of the invention. The largest area comprises touch area (A). This is the main area used for display of a displayed part of a list through which it is desired to scroll. The list may, however, extend vertically into edge areas (B) and (C) and horizontally into areas (D) and (E) and beyond the edges of the screen. Touching the touch screen in the different areas shown has different functionality and moving a finger between the different zones without removing it from the screen can achieve different effects.

When a list is displayed on the touch screen, it can be caused to scroll vertically up or down or horizontally from side-to-side by touching touch area (A) with a finger and moving the finger in the direction in which it is desired to scroll. Preferably the scrolling speed will match the speed with which the finger is moved on touch area (A).

When a finger is brought into contact with touch area (A) and is moved towards either area (B) or (C) the list will scroll vertically up or down respectively. If the finger is moved but continues in contact with the screen into area (B) or (C) then the list will continue to scroll at the speed with which it was scrolling through touch area (A) without slowing down. Thus, the user can scroll through the whole of the list with one finger swipe.

The speed with which the list continues to scroll may be the average speed with which the finger was swiped through touch area (A) or may be the speed with which it exited touch area (A) and entered area (B).

Horizontal scrolling can be achieved by swiping a figure horizontally across touch area (A). If the finger remains in contact with the screen and moves into either touching area (E) or touch area (D) then as in the vertical scrolling the list will continue to scroll without slowing down.

Preferably, a further form of scrolling is available for tabular data by providing diagonally opposite touch sensitive zones in the corners of the screen. This enables diagonal scrolling to be achieved. A finger is swiped diagonally across touch area (A) and finishes its movement in one of the diagonal zones in each corner of the touch screen. Providing the finger remains in contact with the screen the tabular data will scroll diagonally while the finger remains in one of the diagonal zones.

Deceleration and stopping of the scrolling can be achieved in each of the scroll directions. If the finger is removed from the touch screen then scrolling can be configured to stop immediately or to slow down at a predetermined rate. Deceleration can also be triggered if the finger moves back into touch area (A). Again, this can be an immediate stop or can be deceleration at a predetermined rate.

The schematic diagram of FIG. 2 shows the steps performed in hardware/software in response to moving of a finger on the touch area. At 2 the system monitors movement detected on the touch screen. If there is no movement, then the system goes around a loop and periodically checks for movement. If movement is detected then at 4 the content displayed on the screen is moved in the direction of motion of the finger touching the screen, and at a speed determined by the speed of movement of the finger on the screen.

At 6 the system detects the action or movement rate of the finger and uses this to determine the speed with which content should be moved on the screen.

At 8 the system determines whether or not the finger has entered one of the detection zones (A) (C) (D) or (E). Preferably the system has previously determined the direction of movement and therefore only needs to check the detection zone appropriate to that direction of movement.

If the detection zone has been entered, the system then determines at 10 whether a finger which scrolled across area (A) remains down, i.e. in contact with the detection area (B) (C) (D) or (E). If it is, then the contact displayed continues to be scrolled through at the rate it was previously scrolled through and in the direction was previously scrolling at step 14. Once the finger is removed or moves back to touch area (A) then the control flows back to the movement detection step 2.

If after the step of detecting whether a detection zone has been entered at (8) the determination is that it has not, then the system will determine whether the finger remains in contact with the screen at 12. If it does, then the direction of scrolling continues at 16 and the system returns to the detection of movement at 2. If the finger is no longer in contact with touch area (A) then at 18 the content being scrolled through continues to move but at a decreasing rate until it stops. Control then passes back to the movement detection step 2.

The control scheme can be further modified as described above to decelerate or stop the scrolling when the finger is lifted from the screen.

The screen may have the various touch sensitive areas clearly marked on the screen. Alternatively the touch sensitive areas may be defined but not be marked, and a user can be assumed to know where they are.

The above functionality may be implemented in dedicated hardware, or may be implemented in software running on a processor 20 coupled to a touch sensitive screen 22.

1. A touch sensitive screen for scrolling through a set of data displayed on the screen comprising a plurality of touch sensitive areas on the screen, the touch sensitive areas comprising a central area on which a substantial portion of a displayed part of the set of data is displayed, and a plurality of edge portions one for each direction in which it is possible to scroll through the set of data, means responsive to contact and movement on the central area to cause scrolling of the set of data whereby previously undisplayed parts are displayed and move in the direction of scrolling, and means responsive to movement of the contact into one of the edge portions in the direction of scrolling to cause continued scrolling through the set of data.

2. A touch sensitive screen system according to claim 1 in which the means responsive to contact and movement on the central area is also responsive to speed of movement on the central area to cause scrolling of the set of data at a speed dependent on the speed of movement on the central area.

3. A touch sensitive screen system according to claim 2 in which the continued scrolling through the set of data is at a speed dependent on the speed of movement on the central area.

4. A touch sensitive screen system according to claim 1, in which the edge portions comprise upper and lower edge portions.

5. A touch sensitive screen system according to claim 1 in which the edge portions comprise left and right edge portions.

6. A touch sensitive screen system according to claim 1 in which the edge portions comprise lower edge portions.

7. A touch sensitive screen system according to claim 1 in which the means responsive to movement of the contact into one of the edge portions is also responsive to removal of the contact from the screen to stop the scrolling through the set of data.

8. A touch sensitive screen system according to claim 7 in which the stopping of scrolling through the set of data includes a deceleration phase prior to stopping.
